(19) United States
(12) Patent Application Publication
(10) Pub. No.: US 2003/0140253 A1
(43) Pub. Date: Jul. 24, 2003

(54) Method of and apparatus for detecting creation of set user identification (setuid) files, and computer program for enabling such detection

(76) Inventors: Mark Crosbie, Dublin (IE); Benjamin Kuperman, West Lafayette (IN)

Correspondence Address: HEWLETT-PACKARD COMPANY, Intellectual Property Administration, P. O. Box 272400, Fort Collins, CO, 80527-2400, US

(21) Appl. No.: 10/298,219

(22) Filed: Nov. 18, 2002

Related U.S. Application Data
(60) Provisional application No. 60/331,443, filed on Nov. 16, 2001.

(51) Int. Cl. H04L 9/00

(52) U.S. Cl. 713/201

(57) ABSTRACT

The creation of a file with setuid privileges owned by a member of a list of critical owners is detected. Templates are used to monitor for occurrences of the following events: modification of file permissions to enable the setuid bit; changing a setuid file owner to one owner of a list of critical owners; and creation of a file with the setuid bit set. Another embodiment monitors the occurrence of the following events: a first program executing with setuid privilege in turn executes a second program other than the first program; and a program unexpectedly gains elevated privileges without calling a well defined sequence of operating system calls. Another embodiment of the present invention detects unexpected file reference modification, or a so-called “race-condition” attack. A template monitors privileged program file accesses and generates an alert if a file reference appears to have unexpectedly changed.

### RELATED APPLICATIONS

The present application is related to co-pending patent application entitled “COMPUTER ARCHITECTURE FOR AN INTRUSION DETECTION SYSTEM”, (HP Docket No. 10012170-1), filed Jun. 12, 2001, Ser. No. 09/878,320, which is hereby incorporated by reference into this specification in its entirety.

The present application is related to patent application entitled “COMPUTER ARCHITECTURE FOR AN INTRUSION DETECTION SYSTEM”, (HP Docket No. 100012170), filed Jun. 12, 2001, Ser. No. 09/878,319, which is hereby incorporated by reference into this specification in its entirety.

The present application is related to co-pending patent application entitled “METHOD OF GENERATING AND PRESENTING KERNEL DATA” (HP Docket No. 10012172) and assigned to the instant assignee and filed on even date herewith which is hereby incorporated by reference into this specification in its entirety.

The present application claims priority to provisional patent application entitled “METHOD FOR DETECTION OF THE CREATION OF SETUID FILES,” filed Nov. 16, 2001, Serial No. 60/331,443, assigned to the instant assignee and which is hereby incorporated by reference into this specification in its entirety.

The present application is related to co-pending patent application entitled “METHOD OF DETECTING CRITICAL FILE CHANGES,” filed Nov. 16, 2001, Ser. No. 09/987,911, assigned to the instant assignee and which is hereby incorporated by reference into this specification in its entirety.

### FIELD OF THE INVENTION

The present invention relates generally to systems for detection of computer intrusion, and more particularly, to detecting creation of a setuid file, or an enabling of a setuid bit on an existing file, to detect and/or prevent intrusions.

The present invention also relates generally to intrusion detection systems, and more particularly, to a method of detecting when a program executing with setuid privilege in turn executes a program other than itself. The present invention further relates to detecting when a program unexpectedly gains elevated (root) privileges without calling a well defined sequence of system calls.

The present invention also relates generally to intrusion detection systems, and more particularly, to a method of detecting when a file reference appears to have been unexpectedly changed.

### BACKGROUND OF THE INVENTION

Some computer files are known as setuid files, e.g. on a UNIX-based operating system. A typical file has a bit in a header field that is set to indicate whether or not the file is a setuid file. A setuid file, if executed, operates with the permission of the owner of the file, not the person executing the file. One of the frequent ways that an intruder attempts to get into a computer system (i.e., backdoor the system) is to install on the system a copy of a shell program, e.g. /bin/sh, that is a setuid file with root ownership. A root user is a particular account having access to all files on a system. Such a file allows any command to be executed as a superuser, i.e. a user having more permissions than the user executing the file.

Currently, there is no known mechanism for detecting the creation of a setuid file as soon as it occurs. Further, there are no known mechanisms for providing a near real-time report of the creation of setuid files, i.e. no mechanisms are known to exist for HPUX (Hewlett-Packard UNIX operating system).

One of the methods used to gain privileges on a system is to gain access to a normal user account, and then exploit a buffer overflow condition to gain higher access. Currently, there is no known mechanism for detecting an unexpected elevation of privilege as soon as it occurs in order to provide a timely security report to an administrator regarding a potential security intrusion.

There is a class of attacks utilizing the time between when a program checks a file (to see that it exists, or to check some other condition that the file must meet), and the time the program utilizes that file. For example, a mail delivery program might check to see if a file exists before changing the ownership to the intended recipient. If an attacker can somehow change the file reference between these two steps, that attacker can cause the program to change the ownership of a different file.

Currently, there is no known mechanism for detecting an unexpected change made to a file reference as soon as it occurs in order to provide a timely security report to an administrator regarding a potential security intrusion.

### SUMMARY OF THE INVENTION

An embodiment of the present invention detects the creation of a file with setuid privileges owned by a member of a list of critical owners. Templates (described below) are used to monitor for occurrence of the following events:

modification of the permissions on a file to enable the setuid bit;

changing the owner of an setuid file to one owner of a list of critical owners; and

creation of a file with the setuid bit set.

As used herein, the term “setuid intrusion” refers to any of the above events, when performed by an intruder.

These and other aspects of the present invention are achieved by a method of detecting the occurrence of a setuid intrusion, comprising reading events representing various types of system calls and routing events to the appropriate template, wherein the event has multiple parameters. The event is filtered as either a possible intrusion based on the multiple parameters, or a benign event. If the event is filtered as a possible intrusion, an intrusion alert is created.

Another embodiment of the present invention is used to monitor the occurrence of the following events:

a first program executing with setuid privilege in turn executing a second program other than the first program (commonly seen in local root buffer overflows);

a program unexpectedly gains elevated privileges (e.g. root privileges) without calling a well defined sequence of operating system calls.

As used herein, the term “buffer overflow intrusion” refers to either of the above events when performed by an intruder.

These and other aspects of the present invention are achieved by a method of detecting the occurrence of a buffer overflow intrusion, comprising reading events representing various types of system calls and routing events to the appropriate template, wherein the event has multiple parameters. The event is filtered as either a possible intrusion based on the multiple parameters, or a benign event. If the event is filtered as a possible intrusion, an intrusion alert is created.

Another embodiment of the present invention detects unexpected modification of a file reference, or a so-called “race-condition” attack. Templates monitor file accesses that a privileged program makes, and generates an alert if a file reference appears to have unexpectedly changed.

These and other aspects of the present invention are achieved by a method of detecting an unexpected modification of a file reference including reading events representing various types of operating system calls and routing events to the appropriate template, wherein the event has multiple parameters. The event is filtered as either a possible intrusion based on the multiple parameters, or a benign event. If the event is filtered as a possible intrusion, an intrusion alert is created.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is an event flow diagram depicting a process for detecting a setuid intrusion, according to an embodiment of the present invention;

FIG. 2 is an event flow diagram depicting a tracking process for tracking process ID mapping to program filenames according to an embodiment of the present invention;

FIG. 3 is an event flow diagram depicting a detection process for detecting unexpected privilege escalation according to an embodiment of the present invention;

FIG. 4 is an event flow diagram depicting a detection process for detecting race condition intrusions according to an embodiment of the present invention; and

FIG. 5 is an event flow diagram depicting a detection process for detecting an intrusion according to another embodiment of the present invention.

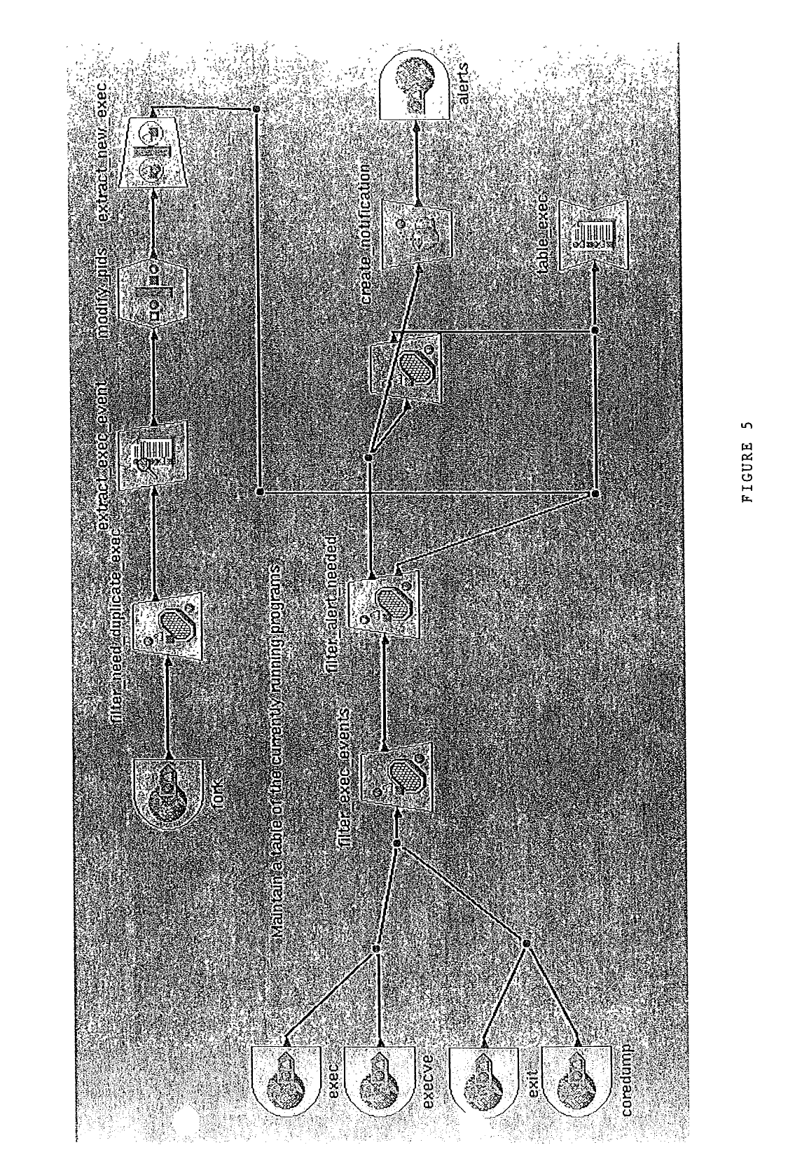

### DETAILED DESCRIPTION OF THE INVENTION

A detection template is a representation of an algorithm embodied in executable instructions to detect an attempt at vulnerability exploitation. For example as described below, a detection template may be written to generate an alert when the setuid bit is enabled on a root owned executable file. The template contains logic, i.e. sequences of processor instructions, for processing a kernel event stream and determining if a file has had the setuid bit enabled. A detection template contains filtering logic to discard events not relevant to the activity for which the template is looking and contains state nodes to record previous event activity for comparison with future activity. Detection template design and use are described in detail in co-pending application titled, “Computer Architecture For An Intrusion Detection System,” hereby incorporated by reference in its entirety.

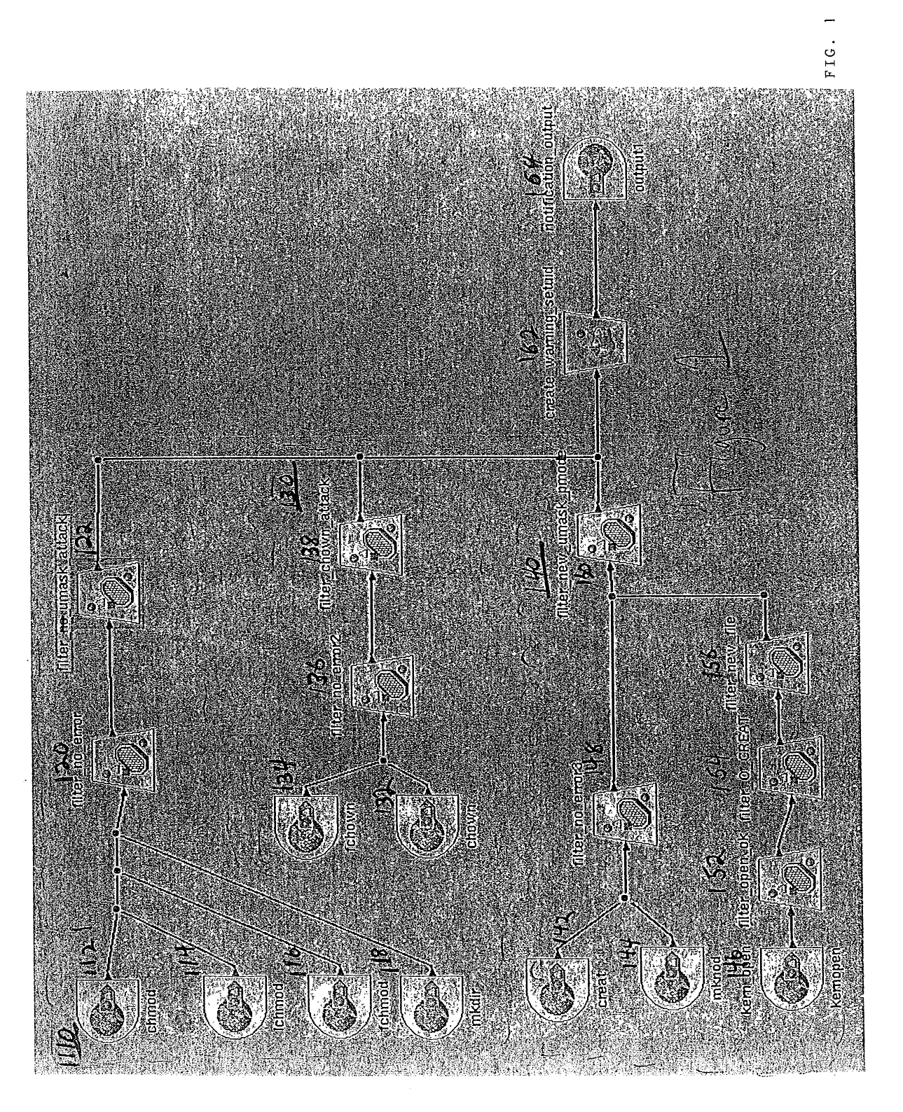

FIG. 1 depicts a visual overview of the template design based on an “event flow” model. Events flow from left-to-right through the nodes in the diagram, and only along the connecting lines.

An event arriving at the input port (depicted on the left hand side) of a node is processed by that node's logic. The logic embedded in the nodes in the event flow diagram contains instructions according to the algorithm used to detect file and directory changes.

An event may leave a node on its output port (depicted on the right hand side of the node). Some nodes create a new event on their output ports; others forward the event that arrived at their input port. Still further, some nodes (e.g. filter nodes) block the input event from transitioning onto the output port, according to the node logic.

“Events” in this context include kernel audit records read from the IDDS subsystem. Each event contains exactly one kernel audit record, pertaining to exactly one operating system call invocation by a process executing on the operating system. As described in the IDDS patent applications entitled “METHOD OF GENERATING AND REPRESENTING KERNEL DATA” and “CIRCUITS FOR INTRUSION DETECTION SYSTEM,” a kernel audit record contains a number of fixed header fields, followed by a variable body portion. Each field in the fixed header and in the variable body portion includes an entry in the event structure used in the template design.

The type of an event is equivalent to the system call information encoded in the event. For example, an open( ) system call will be encoded as a kern_open event type.

FIG. 1 depicts four types of nodes, each using a different shape:

Input node. An input node is a logical representation of an input point into the event flow diagram. Events enter the event flow diagram through an input node. When the idscor process in the intrusion detection system (IDS) receives an audit record from the idskerndsp process, the process encodes the audit record as an event which enters the template via an input node.

Filter node. A filter node acts upon an event presented to its input port and passes the event out one of two output ports: a true port and a false port. Evaluation of a condition encoded in the filter node determines whether the event transits through the node and exits via the true or false output port. An unconnected output port prevents an event from transiting the node, i.e. a condition evaluating such that an event would be provided to an unconnected output port results in removal of the event from the template.

Create node. A create node creates a new event when an event is presented at the input port. The newly created event exits the create node's output port.

Output node, as indicated by a D-shaped node. An output node presents an exit point for events from the flow diagram. An event reaching an output node leaves the event flow diagram and is absorbed by the idscor process.

The template as depicted in the event flow diagram in FIG. 1 consists of three logical areas:

1. Event Input

Gather the events required to determine if an intrusion has occurred. Each event input node is configured to receive one specific type of event. The event type which the node is configured to receive is shown in the name of the node on the diagram. The parameters passed to the operating system call are encoded as field entries in the event structure.

2. Filtering of Events

Filter any events that are not required based on specific parameters in the event.

3. Output Creation

Create an output event containing the intrusion alert derived from the parameters of the input events, and the analysis performed on them.

If any one of these operating system calls is present in the input data to idscor, the template receives the operating system call as an event through the appropriately named input. For example, if the open( ) operating system call is invoked, a kern_open event, identified by reference numeral 146, is created and enters the event flow diagram of FIG. 1 via the kern_open node 146.

Each logical group of nodes in the event flow diagram in FIG. 1 is explained below. Each logical group covers a set of one or more input nodes, connected to a filter node, and optionally connected to a create node.

The first group of events indicating a possible setuid intrusion includes the events in which an existing file without setuid privileges is made to have setuid privileges when its permission bits are changed by a user of the operating system. Such a change can be made using a chmod( ), a lchmod( ) and a fchmod( ) operating system call. Additionally, a directory may have setuid permissions and can be created using a mkdir( ) operating system call. This group of events and the nodes used to filter them is indicated by dashed line box 110.

Below are descriptions of the nodes for the group 110 events in which an existing file without setuid privileges is made to have setuid privileges.

Chmod events enter through an input node chmod 112. Chmod events are generated when the chmod command is used to change the file permissions of a file referenced by the file name.

Fchmod events enter through an input node fchmod 114. Fchmod events are generated when the fchmod command is used to change the permissions of a file referenced by a file descriptor returned from the open( ) operating system call.

Lchmod events enter through an input node lchmod 116. Lchmod events are generated when the lchmod command is used to change the permissions of a symbolic link referenced by the link name.

Mkdir events enter through an input node mkdir 118. Mkdir events are generated when the mkdir command is used to create a directory and set the permission bit values for the directory.

A filter node filter_no_error 120 accepts input from chmod 112, fchmod 114, lchmod 116, and mkdir 118. An input event passes to the output port of filter_no_error node 120 if the parameters of the operating system call indicate that the operating system call outcome was successful, and no errors occurred during the call.

A filter node filter_umask_attack 122 specifies logic to determine if the setuid bit was enabled on the file or directory specified in the event record present on the input port of the node 122. Filter_umask_attack node 122 must also check if the ownership of the file as recorded in the event record is a member of the set of critical owners (described below). If the file owner is not a member of that set then the input event is discarded and does not transit to the output port of filter_umask_attack node 122.

If the file is owned by a member of the set of critical owners and the file setuid bit is enabled, then the input event transits to the output port of the filter_umask_attack node 122.

The default set of critical owners is shown in Table 1 below. The set of critical owners is configurable.

TABLE 1

| User ID | User Name |
|---|---|
| 0 | root |
| 1 | daemon |
| 2 | bin |
| 3 | sys |
| 4 | adm |
| 5 | uucp |
| 9 | lp |
| 11 | nuucp |

The second group of events indicating a possible setuid intrusion includes the events in which an existing file already has setuid privileges, but the file owner is not one of the critical owners. If the file's ownership is then changed to have an owner in the list of critical owners an alert message is generated. This group of events and the nodes used to filter them is indicated by reference numeral 130 (dashed line box).

Below are descriptions of the nodes for the group of events in which the owner of an existing file with setuid privileges is set to an owner in the above list of critical owners.

Chown events enter through an input node chmod 132. Chown events are generated when the chown command is used to change the ownership settings on a file referenced by the filename.

Fchown events enter through an input node fchown 134. Fchown events are generated when the fchown command is used to change the ownership settings on a file referenced by a file descriptor returned from the open( ) operating system call.

A filter node filter_no_error2 accepts input events of type chown or fchown. The logic in the filter_no_error2 node 136 passes the input event to the output port if the parameters to the operating system call indicate that the outcome was successful and no errors occurred during the operating system call.

A filter node filter_chown_attack 138 accepts input events of type chown or fchown from the output port of filter_no_error2 node 136. The logic in filter_chown_attack 138 passes the event record present on the input port to the output port if the parameters encoded in the event record indicate that the ownership or group ownership of the file has been changed, and the file is changed to be owned by a member of the critical owners list as defined above, and the permission bits on the file indicate that setuid privileges are enabled. If any of these conditions are not met then the input event is discarded.

The third group of events, indicated by dashed line box 140, indicating a possible setuid intrusion includes the events in which a new file is created on an operating system with setuid privileges and an ownership from the set of critical owners. If this event occurs then an intrusion alert message must be generated.

Below are descriptions of the nodes for the group of events in which a new file is created with setuid privileges and an ownership from the set of critical owners.

Creat events enter through an input node create 142. Creat events are generated when the creat command is used to create a file with a given filename.

Mknod events enter through an input node mknod 146. Mknod events are generated when the mknod command is used to create a device special file, a pipe and a first-in, first-out (FIFO) device.

Kernopen events enter through an input node kernopen 146. Kernopen events are generated when the kernopen command is used to open a file for reading, writing, truncation, appending, and creation of a new file.

A filter node filter_no_error3 148 accepts input events of type creat or mknod. The logic in filter_no_error3 node 148 passes the input event to the output port if the parameters to the operating system call indicate that the outcome was successful, and no errors occurred during the call.

A filter node filter_new_umask_pmode 150 determines if the permission bits set on the file encoded in the event record on the input port indicate the file was created with setuid privileges. Filter_new_umask_pmode 150 also determines if the file has an owner that is a member of the set of critical owners as defined above. If the file encoded in the event record satisfies both these conditions, the event record will transit to the output port of filter_new_umask_pmode node 150. If the event record does not satisfy both these conditions then the input event is discarded and does not transit to the output port.

A filter node filter_open_ok 152 accepts input events of type kernopen. The logic in filter_open_ok 152 passes the input event to the output port if the parameters to the operating system call indicate a successful outcome and no errors occurred during the call.

A filter node filter_O_CREAT 154 accepts events of type kernopen from the output port of filter_open_ok node 152. Filter_O_CREAT node 154 examines the parameters to the operating system call encoded in the event record present on the input port. If the parameters to the operating system call encoded in the event record indicate a file was created and assigned setuid privileges, and that the file's owner is a member of the set of critical owners, the event record present on the input port transits to the output port of filter_O_CREAT node 154. If the event record does not satisfy the conditions, the event is discarded and does not transit to the output port.

A filter node filter_new_file 156 accepts an event of type kernopen from the output port of filter_O_CREAT node 154. Filter_new_file node 156 examines the parameters to the operating system call encoded in the event record present on the input port. If the parameters to the operating system call encoded in the event record indicate a file existed prior to the occurrence of the open system call encoded in the event record, the event is discarded and does not transit to the output port. If the parameters encoded in the input event indicate the file did not exist prior to the open system call encoded in the input event, then the input event transits to the output port.

The next two nodes create and output the warning to the idscor process. A create node create_warning_setuid 162 creates the alert text indicating a file or directory was granted setuid privileges and the file or directory's owner was a member of the set of critical owners as defined above. Create_warning_setuid 162 gathers the information needed from the input event and creates a text message describing the type of modification, which file or directory was modified, who modified the file or directory, when the file or directory was modified, and how the file or directory was modified.

An output node notification_output 164 outputs received events to the idscor process.

A sample alert message is shown below. Each field of the alert text is separated by a percent (“%”) character. The recipient of the alert message parses the alert message to extract each field by scanning for “%” characters.

%02:FILESYSTEM %Setuid file created %User 0 enabled the setuid bit on file “/tmp/sh” executing /usr/bin/chmod(1,1627,“40000008”) with arguments [“chmod”, “u+s”, “sh”] as PID:22545

File or Directory Change

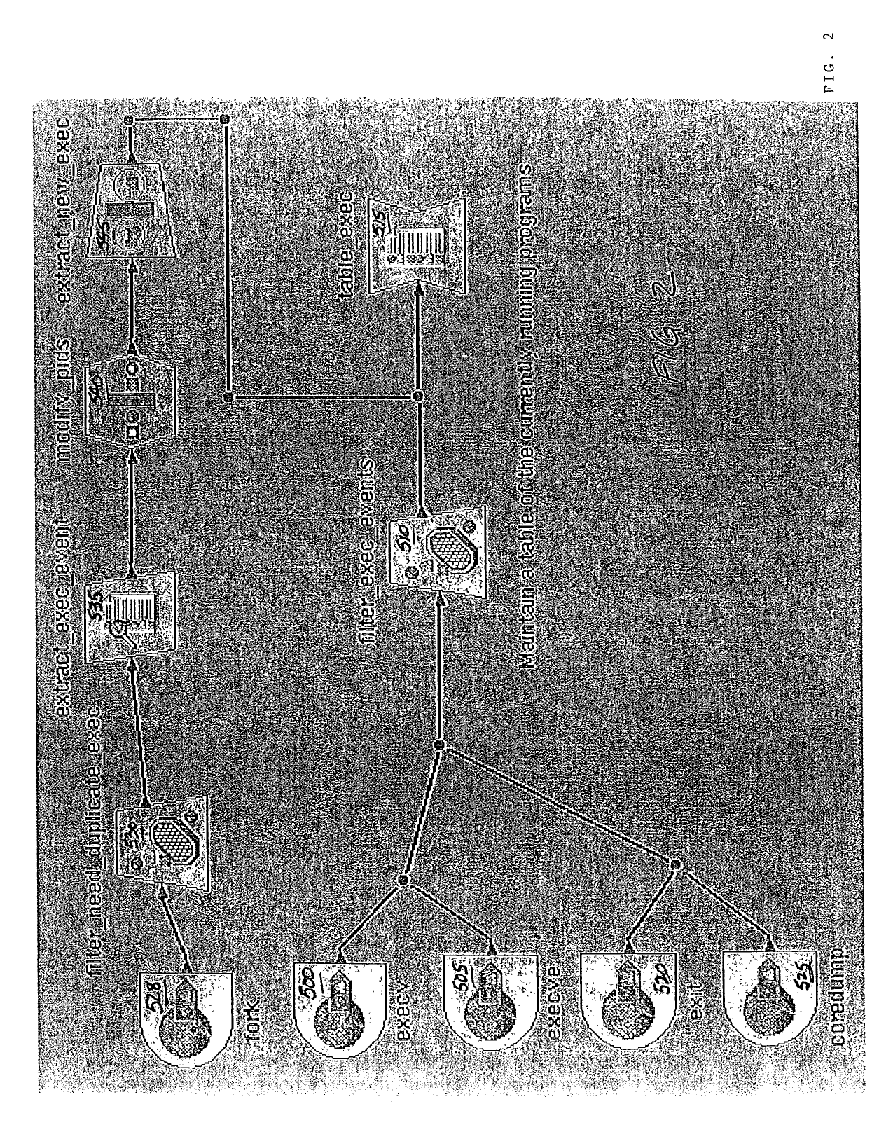

Referring now to FIG. 2, each detection template in the IDS system is required to report the full pathname of the program used to conduct any intrusive activity. For example, if a file or directory is changed or modified, the executable program which makes the change must be included in the intrusion report.

Operating systems use process identifiers (PIDs) to keep track of each process on the operating system. A running or executing process has a unique PID assigned for the duration of the process execution life. However, as soon as the process exits, the process ID may be reused for another process. Thus, PIDs are unique only for the lifetime of a process, not for the lifetime of the system as a whole.

The purpose of the process tracking sub-component of each detection template is to track the invocation of a process on the operating system, and at the time of invocation record the full pathname of the executable program used to execute the process.

For example, the file /usr/bin/vi stored on the filesystem contains code for the editor program vi on a typical UNIX-based operating system. A user executes the editor program and the operating system assigns a PID of 3456 to the process image while the editor program is running. Thus, PID 3456 maps to the filename “/usr/bin/vi”. However, once process 3456 exits, the mapping entry is no longer valid.

The mapping between the PID and the full pathname of the executable is stored in a table. Each process executing on the system corresponds to exactly one table.

Thus, the conditions to be tracked are:

1. A program is invoked and assigned a PID. The PID and associated full pathname are recorded in the table.

2. A currently executing process exits normally. The mapping entry for that PID must be removed from the table.

3. A currently executing process forks (creates) a duplicate copy of itself with a new PID. A copy of the record must be made in the table mapping the new PID to the original full pathname.

4. A currently executing process exits abnormally. The mapping entry for the PID must be removed from the table.

Design of the template including instructions to cause the processor to track the conditions described above is depicted in FIG. 2. The logic embedded in the nodes in the event flow diagram contain the algorithm used to detect file and directory changes.

“Events” in this context are kernel audit records read from the IDDS subsystem. Each event contains exactly one kernel audit record, which pertains to exactly one system call invocation by a process. As described in patent applications entitled “METHOD OF GENERATING AND PRESENTING KERNEL DATA” and “CIRCUITS FOR INTRUSION DETECTION SYSTEM”, a kernel audit record contains a number of fixed header fields, followed by a variable body portion. Each field in the fixed header, and in the variable body portion, has an entry in the event structure used in this template design.

FIG. 2 depicts five types of nodes:

1. An input node. An input node is a logical representation of an input point into the event flow diagram. Events enter the event flow diagram through an input node. When the idscor process in the IDDS receives an audit record from the idskerndsp process, the idscor process encodes the audit record as an event entering the template via the input node.

2. A filter node. A filter node acts upon an event presented to the input port and passes the event out of one of two output ports: a true port and a false port. A condition encoded in the filter node determines whether the event transits through the node and exits via the true or false output port.

3. An extract node. An extract node queries a table and copies an event from the table based on the logic encoded in the node and the contents of the event record present on the input port. In doing so, the node appends the newly modified event to the end of the input event, so the output event is logically a pair of events: (input event, modified event).

4. A modify node. A modify node modifies the contents of the event present on the input port and passes the modified event to the output port.

5. A rearrange node. A rearrange node takes multiple events for input, and only outputs one of them.

6. A table node. A table node stores events for a specified period of time, or until a deletion criteria is met.

If any one of these operating system calls is present in the input data to idscor, the template depicted in FIG. 2 receives the operating system call as an event through the appropriately named input. For example, if the execv( ) operating system call is executed, an execv event is created and enter the event flow diagram via the input node named execv 500.

Storage of the mapping from a PID to a program's filename is handled by the nodes described below.

Exec events enter through an input node exec 500. Exec events are generated when the exec command is used to execute a program using the exec( ) operating system call.

Execve events enter through an input node execve 505. Execve events are generated when the execve command is used to execute a program and specify its environment using the execve( ) operating system call.

A filter node filter_exec_events 510 passes only successful exec, execve, exit or coredump events. If the event record indicates that the operating system call returned with no error, then the event present on the input port of filter node filter_exec_events 510 transits to the output port. If the event record indicates that the operating system call returned an error or failed for any reason, then the event record is dropped and does not appear on the output port of filter node filter_exec_events 510.

A table node table_exec 515 stores the PID to program filename mapping. A table node represents a list of entries, with each entry corresponding to one event record. The contents of a table node can be queried by other nodes in the event flow diagram. For example, extract_exec_event node 535 can query table_exec table node 515 to determine if an entry is already present in the table.

Three parameters define the operation of the table_exec table node:

Max Events

The maximum number of events that will be stored in the table.

Save Until

How long each event will remain in the table (the event's lifetime).

Delete condition

How to choose which events to discard from the table.

The default settings in table_exec 515 are:

Max Events: unlimited

Save Until: 24 hours

Delete Condition: If an exec event record or an execve event record arrive at the input port of the table node, then delete a table entry if the PID field equals the PID field of the event at the input port. Thus the table always contains the latest mapping between a given PID and the corresponding filename. Moreover, if an exit event record or a coredump event record arrive at the input port and have the same PID as a table entry, then the table entry is deleted. Thus, the table only contains an entry for each executing process on the system, and never for a process not currently executing.

When a process exits the following nodes are used:

Exit events enter through an input node exit 520. Exit events are generated to record the exit( ) operating system call and indicate that a process is no longer executing.

Coredump events enter through an input node coredump 525. Coredump events are generated to record the details of a process exiting abnormally because of an error condition.

When a process creates a copy of itself using the fork( ) operating system call 528, the entry in the table must be duplicated.

A filter node filter_need_duplicate_exec 530 passes the fork event record present on the input port to the output port if a table entry for the PID recorded in the fork event record exists in table_exec table node 515. If no table entry is found in table_exec table 515 then the input event record is discarded and does not transit to the output port.

An extract node queries a table and copies an event from the table based on the logic encoded in the node and the contents of the event record present on the input port. In doing so it appends the newly modified event on to the end of the input event, so the output event is logically a pair of events: (input event, modified event).

The extract_exec_event node 535 retrieves a copy of the PID to filename mapping entry in the table_exec table 515 for the event record on the input port and transits the event out the output port.

A modify node modify_pids 540 receives an event from extract_exec_event node 535. This event is logically composed of two events. Modify_pids node 540 modifies the second event in the pair to contain the process ID of the first event in the pair. In doing so, modify_pids node 540 creates a duplicate copy of a PID to filename mapping from table_exec node 515, and modifies the PID entry to refer to the newly created process. The modified event pair transits onto the output port of modify_pids node 540.

A rearrange node extract_new_exec 545 receives an event pair on the input port and chooses the second of the events from the pair and transits the event onto the output port. In this manner, the template detects and tracks file and directory changes in the operating system.

SETUID Privileges

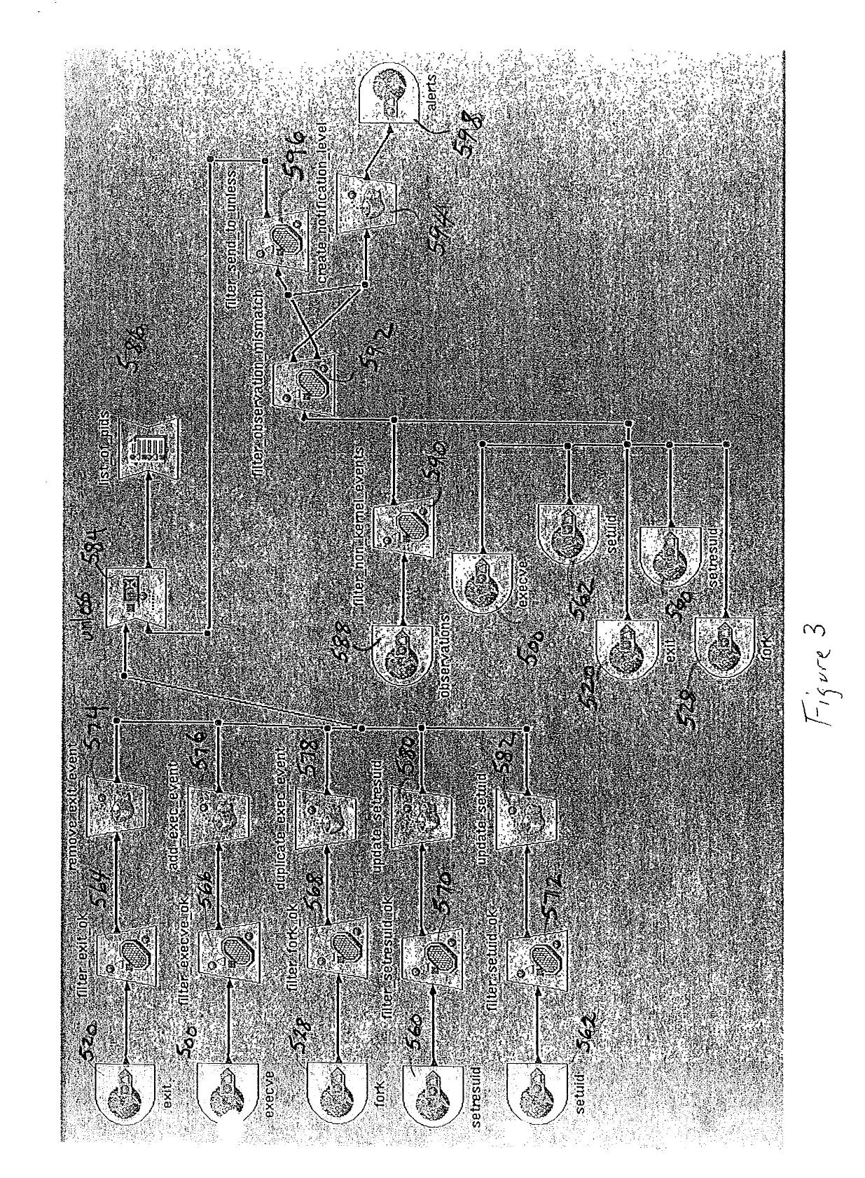

The logic for tracking the execution of setuid privileged binaries is depicted in FIG. 3 and described below. A setuid privileged binary is an executable executing with the access permissions of the file's owner instead of those of the user invoking the program.

The template monitors for the following actions:

1. A first program executing with setuid privilege that in turn executes a second program (commonly seen in local root buffer overflows); and

2. A program unexpectedly gaining elevated (root) privileges without calling a well-defined sequence of operating system calls.

A setuid privileged file is one that, if executed, will operate with the permissions of the owner of the file, not of the person executing the file. One method used to gain privileges on an operating system is to gain access to a normal user account, and then exploit a buffer overflow condition to gain higher access.

This template detects the execution of these type of exploits and generates an alert message as soon as these exploits occur.

The diagram depicted in FIG. 3 includes four types of nodes: an input node, a create node, an output node, and a table node. Each node type has been described above.

If any one of these operating system calls is present in the input data to idscor, the template depicted in FIG. 3 receives the operating system call as an event through the appropriately named input. For example, if the execve( ) system call is executed, an execve event is created and will enter the event flow diagram via the input node name execve 500.

FIG. 3 is now described in detail. Input nodes exit 520, execve 500, and fork 528 are described above. Setresuid events enter through an input node setresuid 560. Setresuid events are generated when the setresuid command is used to set the real, effective and saved user identifier (ID) of a file.

Setuid events enter through an input node setuid 562. Setuid events are generated when the setuid command is used to set the real and/or saved user and group IDs of a file.

Each of the input events, i.e. exit, execve, fork, setresuid, and setuid, are filtered by a corresponding filter node, i.e. filter_exit_ok 564, filter_execve_ok 566, filter_fork_ok 568, filter_setresuid_ok 570, and filter_setuid_ok 572, respectively. Each filter node 564-572 receives an input event from the corresponding input node and passes the event to the output port if the parameters of the operating system call indicate that the operating system call outcome was successful, and no errors occurred during the call.

Next, for each input event successfully transiting a filter node 564-572 to an output port, a corresponding create node, i.e. remove_exit_event 574, add_exec_event 576, duplicate_exec_event 578, update_setresuid 580, and update_setuid 582, respectively, receive an input event from the corresponding filter node, performs an action, and provides an updated table to an unless node 584.

Remove_exit_event 574 extracts a table of processes from a table node list_of_pids 586 and deletes all references to the current process causing invocation of the exit operating system call from the table of processes. After removing all references, remove_exit_event 574 transmits the updated table of processes to unless node 584.

Add_exec_event 576 extracts a table of processes from table node list_of_pids 586 and adds the current process causing invocation of the execve operating system call to the appropriate list, i.e. setuid or normal, of the table of processes depending on the requested user ID change. After adding the current process, add_exec_event 576 transmits the updated table of processes to unless node 584.

Duplicate_exec_event 578 extracts the table of processes from table node list_of_pids 586 and duplicates the current process by creating another process using a new process number in the same list, i.e. setuid or normal, of the table of processes. After duplicating the current process, duplicate_exec_event 578 transmits the updated table of processes to unless node 584.

Update_setresuid 580 and update_setuid 582 extract the table of processes from table node list_of_pids 586 and delete references to the current process, calculate the new executing mode, i.e. setuid or normal, and insert the current process into the appropriate list. After performing the above action, update_setresuid 580 and update_setuid 582 transmit the updated table of processes to unless node 584.

Unless node 584 receives input events from create nodes 574-582, i.e. input events from the nodes and the transmitted updated table of processes, stores the events and received table, and updates the process list, i.e. a table node list_of_pids 586, if a matching event is received from filter_send_to_unless 596. That is, unless node 584 does not update list_of_pids 586 if unless node 584 fails to receive the same event from two input ports.

List_of_pids 586 includes a list of processes in the operating system divided into two groups: normal, where the real and effective user IDs match and setuid, where the real and effective user IDs differ.

An input node observations 588 receives all input events except events having a matching input node elsewhere, e.g. exit, execve, fork, setresuid, and setuid all have matching input nodes and would not be received by observations 588. Observations 588 provides received input events to a filter node filter_non_kernel_events 590.

Filter_non_kernel_events 590 filters events not related to kernel operating system calls and allows kernel input events to transit to the output port.

Input events from input nodes execve 500, setuid 562, exit 520, setresuid 560, and fork 528 in conjunction with filtered input events from filter_non_kernel_events 590 are received at an input port of a filter node filter_observation_mismatch 592. Filter_observation_mismatch filters the input events, compares the current event with the entry for the corresponding process ID in list_of_pids 586, and transits mismatched events, i.e. the case where a privilege has unexpectedly changed, to an output port connected to (1) a create node create_notification_level 594 and (2) a filter node filter_send_to_unless 596 to enable updating of table list_of_pids 586 to occur after receipt by unless node 584.

If the events match, filter_observation_mismatch transits the event to an output port connected to filter_send_to_unless 596.

Filter_send_to_unless 596 determines if the received event would have triggered a change in table list_of_pids 586 and transits the event to the output port for transmission to node 584 if a change would have been triggered.

Create_notification_level 594 creates the alert indicating that a process privilege level has unexpectedly changed during execution. Create_notification_level 594 gathers information needed from the input event and creates a message describing the process changing privilege levels, what was the expected level, and what is the current level.

A sample alert message is shown below. Each field of the alert is separated by a percent (%) character. The recipient of the alert message can parse the alert message to extract each field by scanning for the percent character.

005%01%1%20010821214128%User ID:19447 %14:PROCESSES %Potential buffer overflow %Potential buffer overflow detected with UID:19447(GID:20) EUID:0(EGID:20) executing /home/ids/templates/bo(1,1027,“40000006”) with arguments[“./bo”] now executing: /usr/bin/sh(1,11470,“40000005”) with arguments ( ) as PID:3953

Another template used to detect intrusions is now described.

Privileged Access

The template monitors file accesses by a privileged program and generates an alert if a file reference appears to have unexpectedly changed.

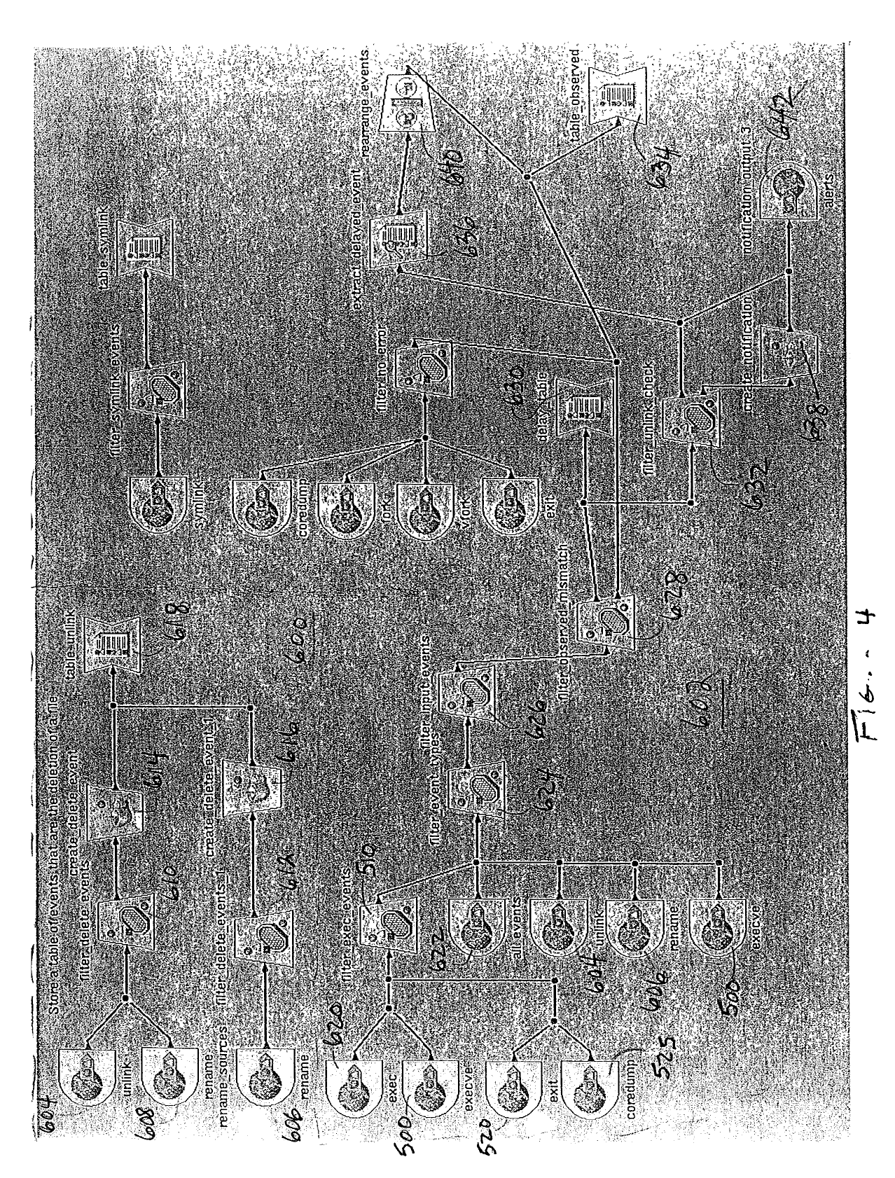

The diagram depicted in FIG. 4 includes six types of nodes: an input node, a filter node, a create node, an output node, a rearrange node, and a table node. Each node type has been described above.

There are two logical groupings of nodes depicted in FIG. 4. The smaller collection of connected nodes, indicated by reference numeral 600 (dashed line box), maintains a table of file deletions. The larger block, indicated by reference numeral 602 (dashed line box), maintains a list of files referenced by selected processes and determines if the files were replaced by someone else between two accesses of the file. Grouping 600 is described first.

Unlink events enter through an input node unlink 604 and include requests that a particular file be removed from a particular directory.

Rename events enter through an input node rename 606 and include operating system calls to rename a directory entry for a specific file to a new name, thereby effectively deleting a file currently listed under the new name.

Rename sources events enter through an input node rename_sources 608 and include operating system calls to rename a file, but considers the fact that renaming a file effectively deletes the current directory entry.

A filter node filter_delete_events 610 filters failed attempts to delete a file, or rename events that do not overwrite an existing file. A filter node filter_delete_events_1 612 filters out failed attempts to rename files received at an input port from rename 606.

A create node create_delete_event 614 and a create_delete_event 616 receive input events from filter_delete_events 610 and create an entry in table node table_unlink 618 containing the operating system call information, file information, old directory information, and the process causing the file to be deleted.

Table node table_unlink 618 maintains a table of file deletions. Table_unlink 618 filters out all deletion events not affecting a file observed by a user of concern (and therefore with an entry in table_observed described below).

The second grouping 602 is now described.

Exec events enter through an input node exec 620.

Input nodes execve 500, exit 520, and coredump 525 and filter node filter_exec_events 510 have been described above. Input nodes exec 620, execve 500, exit 520, and coredump 525 provide input events to filter_exec_events 510.

All events enter through input node all_events 622 and all_events 622 collects all events being audited by the operating system but are not represented by another input node in the template, e.g. exec events enter through input node exec 620 and not all_events 622.

A filter node filter_event_types 624 filters or restricts the operating system calls received as input events to one of the following types:

chmod, chown, coredump, creat, execv, execve, lchmod, lchown, link, lstat, lstat64, mkdir, mknod, mount, open, rename, rmdir, stat, stat64, truncate, truncate64, and unlink.

Each of the above operating system calls involve the use of a file. Filter_event_types 624 only allows the above event types to pass to the output port.

A filter node filter_input_events 626 restricts the events passed through to the output port to those satisfying at least one of the following conditions:

1) Event executed by a privileged user

Default users include all users whose user identifier (UID) is less than 11. This includes root, sys, bin, adm, uucp, daemon, lp, uucp, and others.

The list can be configured by a user.

2) The process is running as a setuid process.

3) The process is about to exec a setuid program.

A filter node filter_observed_mismatch 628 collects information on the current file access and compares the information with saved information regarding file accesses by the process. Filter_observed_mismatch 628 looks for file accesses that are:

by the same process;

for the same symbolic filename;

point to a different file on disk than prior to execution; and

and someone else deleted/renamed the old file.

If the above conditions are met, filter_obesrved_mismatch 628 determines a file mismatch occurred and sends the event to a table node delay_table 630 and a filter node filter_unlink_check 632 for further processing.

If the conditions are not met, the event is considered to be another file access and is sent to a table node table_observed 634.

Table node delay_table 630 stores a single event to be extracted by a node extract_delayed_event 636 (described below).

A filter node filter_unlink_check 632 ensures that the current process did not delete the file (two processes can delete the same file). If the current process was not responsible for the file deletion, the event is sent to a create node create_notification 638. If the current process did delete the file, then there is no need for an alert and the event is sent to extract_delayed_event 636.

Extract_delayed_event 636 extracts the event out of delay_table 630, creates a compound event containing the input event and the event from delay_table 630, and sends the compound event to a rearrange node rearrange_events 640.

Rearrange_events 640 receives the compound event created by extract_delayed_event 636 and converts the compound event into the single event stored in node delay_table 630.

Table node table_observed 634 maintains a table of file observations. Events are filtered earlier in the template and only events of concern reach this node.

A user configurable parameter stores the number of file references per process to be adjusted. The oldest file reference is dropped once the preset limit is exceeded. New file references simply update old file references.

Upon the termination of a process (exit or coredump) all saved file references are purged from table table_observed 634.

A create node create_notification 638 receives input from filter_unlink_check 632 and generates the alert indicating a TOCTTOU (race condition) attack occurred, and that such an attack was against either a selected UID or a setuid process. Create_notification 638 gathers information needed for the alert from the input event and creates a message describing the first file observation, the file observation indicating a mismatch occurred, when the mismatch occurred, the process running that was accessing the files, and information on the process that deleted the file in question.

The output of create_notification 638 is sent to extract_delayed_event 636 and to the notification_output 642.

Create_notification 638 creates the alert text indicating that a file or directory was granted setuid privileges and that the file or directory's owner was a member of the set of critical owners as defined above. Create_notification 638 gathers the information needed from the input event and creates a text message describing the type of modification, what file or directory was modified, who modified the file or directory, when the file or directory was modified, and how the file or directory was modified.

A sample alert message is shown below. Each field of the alert is separated by a percent (%) character. The recipient of the alert message can parse the alert message to extract each field by scanning for the percent character.

006%01%1%20010821203735%User ID:19245 %02:FILESYSTEM %Filename mapping change %UID:19245 (EUID:0) Reference:./runme currently kern_stat:./attack.sh(1,179,“40000004”) was kern_stat:./suid.sh(1,178,“40000004”) program running is “UNKNOWN” with arguments “UNKNOWN” probable ATTACKER was UID:19245 running “UNKNOWN” with arguments “UNKNOWN”

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of detecting a setuid intrusion, comprising:
reading events representing various types of operating system calls;
routing an event to an appropriate template, the event having multiple parameters;
filtering the event as either a possible intrusion based on the multiple parameters or a benign event, and either outputting the event or dropping the event, respectively;
repeating said filtering step zero or more times; and
creating an intrusion alert if an event is output from the final iteration of said filtering step.

2. The method of claim 1, wherein the final iteration of said filtering step outputs an event if the parameters indicate that the setuid permission on a file or directory was enabled.

3. The method of claim 2, wherein the final iteration of said filtering step outputs an event if the further condition is met of the parameters indicating that the owner of said file or directory is one of a set of critical owners.

4. The method of claim 1, wherein the final iteration of said filtering step outputs an event if the parameters indicate that the ownership was changed for a file or directory with setuid permission enabled.

5. The method of claim 4, wherein said final iteration of said filtering step outputs an event if the further condition is met of the parameters indicating that the new owner of said file or directory is one of a set of critical owners.

6. The method of claim 1, wherein the final iteration of said filtering step outputs an event if the parameters indicate that a file or directory was created with setuid permission.

7. The method of claim 6, wherein said final iteration of said filtering step outputs an event if the further condition is met of the parameters indicating that the new owner of said file or directory is one of a set of critical owners.

8. A method of detecting a file pathname intrusion, comprising:
reading events including encoded information representing operating system calls related to file pathname changes;
filtering the event as either a possible intrusion based on the encoded information or a benign event, and either outputting the event or dropping the event, respectively;
repeating said filtering step zero or more times; and
creating an intrusion alert if an event is output from the final iteration of said filtering step.

9. The method of claim 8, wherein the final iteration of said filtering step outputs an event if the parameters indicate that a file pathname was modified.

10. The method of claim 8, further including the step of recording a PID and full pathname of an invoked program.

11. The method of claim 10, wherein the final iteration of said filtering step outputs an event if the parameters indicate that a currently executing program exits normally.

12. The method of claim 10, wherein the final iteration of said filtering step outputs an event if the parameters indicate that a currently executing process creates a copy with a new PID and further comprising the step:
storing a copy of the new PID and original full pathname of the invoked program.

13. The method of claim 10, wherein the final iteration of said filtering step outputs an event if the parameters indicate that a currently executing program exits abnormally and further comprising the step:
removing the stored copy of the PID and full pathname of the invoked program.

14. The method of claim 10, further comprising the step:
maintaining a list of currently executing programs.

15. A method of detecting an intrusion of an operating system, comprising:
monitoring operating system calls for occurrence of one or more events;
determining whether the one or more events are an intrusion; and
generating an alert if the event is determined an intrusion.

16. The method of claim 15, wherein the one or more events include modification of file permissions enabling a setuid bit, modifying the owner of a setuid file to an owner on a critical owner list, and creating a file with a setuid bit enabled.

17. The method of claim 15, wherein the one or more events include a first program executing with setuid privilege executing a second program, a program unexpectedly gaining elevated privileges without calling a well-defined sequence of operating system calls.

18. The method of claim 15, wherein the event includes multiple parameters and wherein the determining step further comprises filtering events as intrusions based on one or more of the multiple parameters.

19. A computer system for detecting an intrusion, comprising:
a processor; and
a memory coupled to the processor, the memory having stored therein sequences of instructions which, when executed by the processor, cause said processor to perform the steps of:
reading operating system call events; wherein the events include zero or more parameters;
filtering the events based on an intrusion template and the zero or more event parameters to determine whether the event is an intrusion event or a benign event;
if the event is determined a benign event, discontinuing filtering of the event;
repeating filtering of the event based on the intrusion template; and
if the event is determined an intrusion event, generating an intrusion alert.

20. The system of claim 19, wherein the intrusion template identifies an intrusion event as one of modification of file permissions enabling a setuid bit, modifying the owner of a setuid file to an owner on a critical owner list, and creating a file with a setuid bit enabled, a first program executing with setuid privilege executing a second program, a program unexpectedly gaining elevated privileges without calling a well-defined sequence of operating system calls.
